(19) United States
(12) Patent Application Publication
(10) Pub. No.: US 2009/0087711 A1
(43) Pub. Date: Apr. 2, 2009

(54) FUEL CELL ELECTRODE, FUEL CELL, AND FUEL CELL STACK

(75) Inventors: Masataka Ueno, Tokyo (JP); Hiroyuki Yamakawa, Tokyo (JP); Hiroki Tsukamoto, Tokyo (JP)

Correspondence Address: BACON & THOMAS, PLLC, 625 SLATERS LANE, FOURTH FLOOR, ALEXANDRIA, VA, 22314-1176, US

(73) Assignee: KABUSHIKI KAISHA EQUOS RESEARCH, Tokyo (JP)

(21) Appl. No.: 12/086,293

(22) PCT Filed: Oct. 31, 2006
(86) PCT No.: PCT/JP2006/321733

§ 371 Date: Jun. 10, 2008

(30) Foreign Application Priority Data
Dec. 16, 2005 (JP) 2005-362556

(51) Int. Cl. H01M 8/10; H01M 4/86

(52) U.S. Cl. 429/30; 429/40

(57) ABSTRACT

This invention provides an electrode for a fuel battery, which can improve both current collection properties and oxidizing gas and/or fuel feedability by allowing produced water to be more easily removed, and a cell for a fuel battery, and a stack for a fuel battery. The electrode for a fuel battery comprises a net material (51, 52), a microporous layer (MPL) (51b, 52b) formed integrally on one side of the net material (21, 22), and a catalyst layer (51c, 52c) formed integrally on one side of the net material (21, 22) closer to the surface. The net material (51, 52) is in a plate form and has an electrically conductive material plate (53) on its other side. The microporous layer (51b, 52b) has a number of interconnected micropores and, at the same time, is electrically conductive and repellent to water. The net material (51, 52) has a number of interconnected voids and, at the same time, is electrically conductive, and each void, together with the plate (53), constitutes an air chamber or a fuel chamber. The catalyst layer (51c, 52c) abuts against an electrolyte membrane (54).

### TECHNICAL FIELD

The present invention relates to a fuel cell electrode, a fuel cell, and a fuel cell stack.

### BACKGROUND ART

In an ordinary fuel cell stack like that disclosed in Patent Document 1, a plurality of cells 10 are stacked, as shown in FIG. 14. Each of the cells 10 is constructed from a separator 12 that is made from an electrically conductive material, a membrane electrode assembly (MEA) 11, and another separator 12. Adjacent cells 10 share the separator 12.

Each of the membrane electrode assemblies 11 includes an electrolytic membrane 11a that is made of a solid polymer membrane such as Nafion® (made by Dupon) or the like, a cathode 11b that is joined to one face of the electrolytic membrane 11a and is supplied with an oxidizing gas, and an anode 11c that is joined to another face of the electrolytic membrane 11a and is supplied with a fuel. The cathode 11b and the anode 11c are electrodes for the fuel cell.

As shown in FIG. 15, the cathode 11b includes a catalyst layer 13a that is positioned adjacent to the electrolytic membrane 11a and a diffusion layer 13b that is adjacent to the catalyst layer 13a and diffuses the oxidizing gas. The catalyst layer 13a includes a catalyst carrier carbon, in which a catalyst is carried by carbon particles, and an electrolytic solution.

The anode 11c includes a catalyst layer 14a that is positioned adjacent to the electrolytic membrane 11a and a diffusion layer 14b that is adjacent to the catalyst layer 14a and diffuses the fuel. The catalyst layer 14a includes a catalyst carrier carbon and an electrolytic solution.

As shown in FIG. 14, each of the separators 12 is stacked such that it is sandwiched between the membrane electrode assemblies 11. A plurality of groove-shaped oxidizing gas flow passages 12b is formed in one face of each of the separators 12 on the side toward the cathode 11b by providing ribs in a sheet-like member. In the same manner, a plurality of fuel flow passages 12c is formed in another face of each of the separators 12 on the side toward the anode 11c. Each of the oxidizing gas flow passages 12b and each of the fuel flow passages 12c extend in a direction such that each of the oxidizing gas flow passages 12b and each of the fuel flow passages 12c are mutually orthogonal. Furthermore, the oxidizing gas that is supplied to the stack flows through all of the oxidizing gas flow passages 12b in each of the cells 10, and the fuel that is supplied to the stack is flows through all of the fuel flow passages 12c in each of the cells 10.

In the stack, an electrochemical reaction between the oxidizing gas that is supplied to the oxidizing gas flow passages 12b and the fuel that is supplied to the fuel flow passages 12c gives rise to an electromotive force. Optimizing the pitches and the depths of the oxidizing gas flow passages 12b and the fuel flow passages 12c of the separators 12 effectively optimizes both the power collection performance of the stack and the supply performance for both the oxidizing gas and the fuel.

Patent Document 1: Japanese Patent Application Publication No. JP-A-3-295176

### DISCLOSURE OF THE INVENTION

### Problem to be Solved by the Invention

However, the electrochemical reaction is a reaction that is accompanied by the formation of water. The water that is formed blocks the oxidizing gas flow passages 12b and the fuel flow passages 12c that are provided in the separators 12 in the cells 10 and the stack and also blocks gas flow passages in the electrodes 11b, 11c. The flow of the water mixes with the flow of air, thus creating locations where the reaction does not occur and diminishing performance.

In addition, the power collection performance of the cells 10 and the stack is readily influenced by the effects of the pitches and the groove depths of the oxidizing gas flow passages 12b and the fuel flow passages 12c in the separators 12 (drying and a decrease in contact surface area due to the flow rate of the gas), such that power collection loss tends to occur.

In light of the known situation described above, a problem to be solved by the present invention is to differentiate the flow passages through which the water that is formed passes from the flow passages through which at least one of the oxidizing gas and the fuel pass in the electrodes and the separators, based on a basic concept of creating a two-layer flow that separates the flow of the air from the flow of the water in the interior of the fuel cell, thus supplying the gas and draining away the water. Another problem to be solved by the present invention is thereby to provide a fuel cell electrode, a fuel cell, and a fuel cell stack that, by facilitating the draining of the water that is formed, can also improve the power collection performance and the supply performance for at least one of the oxidizing gas and the fuel.

### Means for Solving the Problem

The fuel cell electrode of the present invention is characterized by including a porous body that is shaped like a sheet, that is provided on one face with a plate that is made of an electrically conductive material, that has a plurality of mutually continuous open spaces and is electrically conductive, with each of the open spaces forming one of an air chamber and a fuel chamber between the porous body and the plate, and by including a catalyst layer that is formed as a single unit with the porous body on another face of the porous body and that is in contact with an electrolytic membrane.

In the fuel cell electrode of the present invention, the one of the air chamber and the fuel chamber is formed between the porous body and the plate by each of the mutually continuous open spaces. One of the oxidizing gas and the fuel can be conveyed by the one of the air chamber and the fuel chamber, respectively, and the water that is formed is diffused in the thickness direction by the surface tension of the porous body, such that formation of a blockage by the water that is formed is inhibited. Therefore, in a cell that uses the fuel cell electrode as a cathode and as an anode, the water that is formed is less likely to form a blockage, so a pressure loss in the oxidizing gas and the like tends not to occur, and excellent supply performance can be achieved.

In the one of the air chamber and the fuel chamber, the water that is formed and that accumulates in droplets in the vicinity of the catalyst layer is diffused in the thickness direction by the surface tension of the porous body, such that drying of the upstream side of the electrode is inhibited. In addition, a plurality of electrically conductive columnar portions of the porous body are in contact with the catalyst layer, so a stable contact surface area can be ensured. This makes it possible to achieve excellent power collection performance in the cell.

Therefore, the fuel cell electrode of the present invention can improve both the power collection performance and the supply performance for at least one of the oxidizing gas and the fuel. This improves the output density and the efficiency of the electric power generation of the cell, and by extension, of the stack.

In Japanese Patent Application Publication No. JP-A-2000-58072, a fuel cell is disclosed that includes a separator that has a plurality of grooves that serve as at least one of oxidizing gas flow passages and fuel flow passages, a fuel cell electrode, and an electrolytic membrane. The fuel cell electrode includes a catalyst layer that is positioned on a side toward the electrolytic membrane and a diffusion layer that is adjacent to the catalyst layer. The diffusion layer is a porous body that is made of metal. In this cell, the separator conveys the oxidizing gas and the like, while the diffusion layer conveys electrons, the oxidizing gas and the like, drained water, and heat, such that both the separator and the diffusion layer function to convey the oxidizing gas and the like. Thus the cell is made thicker to the extent that the grooves are formed in the separator, and the gas supply performance and the water drainage performance is poorer on the bottom faces of ribs that form the grooves. This raises concerns about diminished efficiency in electric power generation, lower output density, larger fuel cell size, and higher cost.

With respect to these points, in the fuel cell electrode of the present invention, the porous body conveys the oxidizing gas and the like, so the sheet-like plate can be used without any need to use the separator that has the oxidizing gas flow passages and the like. Accordingly, the cell can be made thinner to the extent that it is acceptable not to form the grooves, and the effects achieved include improved efficiency of electric power generation, improved output density, a more compact fuel cell, and lower cost.

The porous body is shaped like a sheet. The plate that is made of the electrically conductive material is provided on one face of the porous body. The plate has the function of the conventional separator. The porous body also has the plurality of the mutually continuous open spaces. It is desirable for the minimum inside diameter of the open spaces to be from 10 μm to 500 μm. The porous body is also electrically conductive.

The catalyst layer is formed as a single unit with the porous body on another face of the porous body. The catalyst layer can include a catalyst carrier carbon, in which a catalyst is carried by carbon particles, and can be electrolytic. The catalyst layer is in contact with the electrolytic membrane.

The porous body can be made of a foam material that has continuous air bubbles, but it is desirable for the porous body to made from a mesh material that forms a three-dimensional mesh. This is because the size of the open spaces, the electrical conductivity, the surface tension, and the like can be easily controlled by selecting the fibers that form the mesh material, the density of the fibers, and the like. It is desirable for the diameter of the fibers to be no greater than 100 μm, the pore rate of the mesh material to be no greater than 90%, the thickness of the mesh material to be from 0.5 to 2 mm, and the hydrophilicity to be such that the contact angle of water is less than 50 degrees. The mesh material can be one of a woven material and a non-woven material. It is desirable for metal fibers to be aligned as much as possible in a direction that is orthogonal to the surface of the electrode. It is desirable from the standpoint of controlling the open spaces, the electrical conductivity, and the like for fibers of at least two different diameters to be used. It is desirable for the density of the fibers to become progressively higher in the downstream direction of the flow of the gases and the like.

Further, in the porous body, the mesh material can have a diagonal structure in the thickness direction, with the density of the fibers that form the mesh material being greater on the side toward the electrolytic membrane and lower on the side toward the plate. This is achieved by making the diameters of the fibers on the plate side greater. This makes the diameters of the open spaces on the plate side relatively large and the diameters of the open spaces on the electrolytic membrane side relatively small, making it possible both to reduce gas pressure loss and to improve power collection efficiency.

In a case where the mesh material that is made of fibers is used as the porous body, electrically conductive fibers are used because it is necessary for the mesh material to be electrically conductive. Ordinarily, corrosion-resistant, electrically conductive metal fibers made of titanium, SUS, tantalum, hastelloy, and the like are used as the electrically conductive fibers, but fibers that are made of nickel, carbon, and the like can also be used.

It is preferable for the porous body to be both electrically conductive and hydrophilic. In order to impart hydrophilicity to the mesh material, fibers that are both electrically conductive and hydrophilic can be used, and electrically conductive fibers and hydrophilic fibers can be used at the same time. Electrically conductive fibers made of nickel, titanium, SUS, tantalum, carbon, and the like that have undergone a hydrophilicization treatment can be used as the fibers that are both electrically conductive and hydrophilic. An alkaline treatment, an oxidation treatment, or the like of the surfaces can be used as the hydrophilicization treatment. Metal oxide whiskers, plant fibers, and the like can be used as the hydrophilic fibers.

It is desirable for hydrophilic drain layers to be formed over the entire surfaces of the porous body and the plate. It is also desirable for the drain layers to have a water-absorbing function. In a case where a drain layer is formed on the plate side, the face of the plate that is in contact with the porous body can be given a hydrophilicization treatment. An alkaline treatment, an oxidation treatment, or the like of the surface can be used as the hydrophilicization treatment. In a case where a drain layer is formed on the porous body side, it is desirable for the hydrophilic drain layer to be formed over the entire surface that is in contact with the plate. In this case, the droplets of water that diffuse in the thickness direction of the porous body are collected in the drain layer, and the collected water flows through the drain layer of its own weight or under air pressure and is preferably drained to the outside of the fuel cell. It is desirable for the contact angle of water in the drain layer to be less than 50 degrees and even more desirable for it to be less than 30 degrees. It is also desirable for the water absorption rate of the drain layer to be higher than 50% and even more desirable for it to be higher than 100%. It is also possible for hydrophilic drain layers to be formed on both the porous body and the plate.

It is desirable for a micro-porous layer (MPL) that has a plurality of mutually continuous micro-pores and is electrically conductive to be provided between the porous body and the catalyst layer. The micro-porous layer does not have a catalyst layer. In a case where the micro-porous layer is provided, electrons move easily from the catalyst layer to the porous body, and water in the catalyst layer moves to the micro-porous layer, such that the electrochemical reaction in the catalyst layer is less likely to be inhibited. It is desirable for the minimum inside diameter of the micropores to be from 0.01 μm to several μm, with a peak at no greater than 2 μm. It is desirable for the thickness of the micro-pores to be no greater than 200 μm.

It is desirable for the micro-porous layer to be water-repellent. This makes it easier for the water that moves within the micro-porous layer to be drained out from the micro-pores layer, thus improving the efficiency of electric power generation and the output density. The micro-porous layer can be made from carbon particles and polytetrafluoroethylene (hereinafter called “PTFE”) particles. It is desirable for the amount of the PTFE to be from 20% to 60% by mass. It is desirable for the water repellency to be such that the contact angle of water is at least 120 degrees. It is desirable for the micro-porous layer to interpenetrate at least 30 μm into the porous body, and for the opposite face from the interpenetrating face to be smoother than the porous body.

The micro-porous layer can also contain an electrically conductive filler. In this case, the electron resistance is diminished, and the efficiency of electric power generation and the output density are improved.

The fuel cell of the present invention can be built using the fuel cell electrode of the present invention. The cell of the present invention includes a cathode that is made from the fuel cell electrode described above, the plate that is provided on one face of the cathode, an anode that is made from the fuel cell electrode, the plate that is provided on another face of the anode, and the electrolytic membrane that is provided between another face of the cathode and one face of the anode and is in contact with the catalyst layer.

The cell of the present invention can improve both the power collection performance and the supply performance for at least one of the oxidizing gas and the fuel.

It is desirable for a hydrophilic drain layer to be formed over the entire surface of the plate on the side toward the porous body. It is also desirable for the drain layer to have a water-absorbing function. The drain layer may be formed by subjecting the plate itself to a hydrophilicization treatment, and in a case where the water-absorbing function is added, the layer may also be formed from an electrically conductive polymer. In this case, in the same manner as with the drain layer on the porous body, the droplets of water that diffuse in the thickness direction over the columnar portions of the porous body are collected in the drain layer, and the collected water flows through the drain layer of its own weight or under air pressure and is preferably drained to the outside of the fuel cell.

The fuel cell stack of the present invention can be built using the cell of the present invention. In the stack of the present invention, a plurality of the cells are electrically connected in series.

The stack of the present invention can improve both the power collection performance and the supply performance for at least one of the oxidizing gas and the fuel.

It is also possible to add features to the present invention as described below.

(1) A fuel cell includes a membrane electrode assembly that has an electrolytic membrane, a cathode that is joined to one face of the electrolytic membrane and is supplied with air, and an anode that is joined to another face of the electrolytic membrane and is supplied with fuel. The fuel cell also includes a pair of separators that are made from an electrically conductive material and that sandwich the membrane electrode assembly such that an air chamber is formed on the cathode side and a fuel chamber is formed on the anode side. Each of the separators includes a plate that is shaped like a sheet and is made of an electrically conductive material, as well as a first mesh member that is provided on one face of the plate, that is electrically conductive and hydrophilic, that is formed into a porous shape that has a plurality of mutually continuous open spaces, and that forms one of the air chamber and the fuel chamber in each of the open spaces.

(2) On another side of the plate in the fuel cell described in (1) above, a second mesh member is formed that is electrically conductive and hydrophilic, that is formed into a porous shape that has a plurality of mutually continuous open spaces, and that forms one of the air chamber and the fuel chamber in each of the open spaces. In this cell (2), as described above, the air chamber is formed on the cathode side and the fuel chamber is formed on the anode side, making it possible to improve both the power collection performance and the supply performance for the oxidizing gas and the fuel. In a case where the first mesh member is on the cathode side and the second mesh member is on the anode side, it is desirable for the contact angle of water in the first mesh member to be less than 50 degrees and for the contact angle of water in the second mesh member to be less than 40 degrees.

(3) In the fuel cell described in (2) above, in at least one of the first mesh member and the second mesh member, a three-dimensional mesh is formed by electrically conductive fibers and hydrophilic fibers, such that one of the air chamber or the fuel chamber and the fuel chamber or the air chamber is respectively formed between the fibers.

(4) In either of the fuel cells described in (2) and (3) above, in at least one of the first mesh member and the second mesh member, a hydrophilic drain layer is formed on the side toward the plate.

(5) In any one of the fuel cells described in (1) to (4) above, in at least one of the first mesh member and the second mesh member, a water-repellent micro-porous layer is formed on the side toward the membrane electrode assembly. In this case, water diffuses easily from the membrane electrode assembly side to the plate side. It is desirable for the contact angle of water in the micro-porous layer to be greater than 100 degrees and it is even more desirable for it to be greater than 120 degrees.

(6) In any one of the fuel cells described in (1) to (5) above, the membrane electrode assembly is formed from a catalyst layer and one of the first mesh member and the second mesh member, the catalyst layer being positioned on the side toward the electrolytic membrane. In this case, the one of the first mesh member and the second mesh member plays the role of the conventional diffusion layer. This makes it possible to simplify the structure of the membrane electrode assembly and to reduce the manufacturing cost.

(7) A fuel cell stack is made by stacking a plurality of any one of the fuel cells described in (1) to (6) above.

(8) A fuel cell includes a first mesh member that is formed into a sheet-like mesh made of electrically conductive, hydrophilic fibers, with a hydrophilic drain layer being formed on one face and a water-repellent micro-porous layer being formed on another face. The fuel cell also includes a second mesh member that is formed into a sheet-like mesh made of electrically conductive, hydrophilic fibers, with a hydrophilic drain layer being formed on one face and a water-repellent microporous layer being formed on another face. The fuel cell also includes a plate that is formed into a sheet shape made of an electrically conductive material, with a first recessed portion that accommodates the first mesh member provided on one face and a second recessed portion that accommodates the second mesh member and a third recessed portion that accommodates a membrane electrode assembly provided on another face. The fuel cell also includes the membrane electrode assembly, which includes an electrolytic membrane, a cathode that is joined to one face of the electrolytic membrane and includes a catalyst layer, and an anode that is joined to another face of the electrolytic membrane and includes a catalyst layer. The plate is provided with a pair of oxidizing gas passages that are respectively continuous with opposite ends of the first recessed portion and a pair of fuel passages that are respectively continuous with opposite ends of the second recessed portion. The first mesh member is accommodated in the first recessed portion such that the drain layer is in contact with a bottom face of the first recessed portion, and the second mesh member is accommodated in the second recessed portion such that the drain layer is in contact with a bottom face of the second recessed portion.

(9) A fuel cell includes a first mesh member that is formed into a sheet-like mesh made of electrically conductive fibers and hydrophilic fibers, with a hydrophilic drain layer being formed on one face and a water-repellent micro-porous layer being formed on another face. The fuel cell also includes a second mesh member that is formed into a sheet-like mesh made of electrically conductive, hydrophilic fibers, with a hydrophilic drain layer being formed on one face and a water-repellent microporous layer being formed on another face. The fuel cell also includes a plate that is formed into a sheet shape made of an electrically conductive material, with a first recessed portion that accommodates the first mesh member provided on one face and a second recessed portion that accommodates the second mesh member and a third recessed portion that accommodates a membrane electrode assembly provided on another face. The fuel cell also includes the membrane electrode assembly, which includes an electrolytic membrane, a cathode that is joined to one face of the electrolytic membrane and includes a catalyst layer, and an anode that is joined to another face of the electrolytic membrane and includes a catalyst layer. The plate is provided with a pair of oxidizing gas passages that are respectively continuous with opposite ends of the first recessed portion and a pair of fuel passages that are respectively continuous with opposite ends of the second recessed portion. The first mesh member is accommodated in the first recessed portion such that the drain layer is in contact with a bottom face of the first recessed portion, and the second mesh member is accommodated in the second recessed portion such that the drain layer is in contact with a bottom face of the second recessed portion.

(10) A fuel cell includes a first mesh member that is formed into a sheet-like mesh made of electrically conductive, hydrophilic fibers, with a hydrophilic drain layer being formed on one face and a water-repellent micro-porous layer being formed on another face. The fuel cell also includes a separator that is formed into a sheet shape made of an electrically conductive material, with a first recessed portion that accommodates the first mesh member provided on one face, a third recessed portion that accommodates a membrane electrode assembly provided on another face, and a plurality of groove-shaped fuel flow passages that are formed by ribs on a bottom face of the third recessed portion. The fuel cell also includes the membrane electrode assembly, which includes an electrolytic membrane, a cathode that is joined to one face of the electrolytic membrane and includes a catalyst layer, and an anode that is joined to another face of the electrolytic membrane and includes a catalyst layer and a diffusion layer. The separator is provided with a pair of oxidizing gas passages that are respectively continuous with opposite ends of the first recessed portion and a pair of fuel passages that are continuous with the fuel flow passages. The first mesh member is accommodated in the first recessed portion such that the drain layer is in contact with a bottom face of the first recessed portion.

(11) A fuel cell includes a second mesh member that is formed into a sheet-like mesh made of electrically conductive, hydrophilic fibers, with a hydrophilic drain layer being formed on one face and a water-repellent micro-porous layer being formed on another face. The fuel cell also includes a separator that is formed into a sheet shape made of an electrically conductive material, with a third recessed portion that accommodates a membrane electrode assembly provided on one face, a plurality of groove-shaped oxidizing gas flow passages that are formed by ribs on a bottom face of the third recessed portion, and a second recessed portion that accommodates the second mesh member provided on another face. The fuel cell also includes the membrane electrode assembly, which includes an electrolytic membrane, a cathode that is joined to one face of the electrolytic membrane and includes a catalyst layer and a diffusion layer, and an anode that is joined to another face of the electrolytic membrane and includes a catalyst layer. The separator is provided with a pair of oxidizing gas passages that are continuous with the oxidizing gas flow passages and a pair of fuel passages that are respectively continuous with opposite ends of the second recessed portion. The second mesh member is accommodated in the second recessed portion such that the drain layer is in contact with a bottom face of the second recessed portion.

(12) A fuel cell includes a first mesh member that is formed into a sheet-like mesh made of one of electrically conductive, hydrophilic fibers and both electrically conductive fibers and hydrophilic fibers, with a water-repellent micro-porous layer being formed on one face and a catalyst layer being formed on the same face. The fuel cell also includes a second mesh member that is formed into a sheet-like mesh made of one of electrically conductive, hydrophilic fibers and both electrically conductive fibers and hydrophilic fibers, with a water-repellent micro-porous layer being formed on one face and a catalyst layer being formed on the same face. The fuel cell also includes a plate that is formed into a sheet shape made of an electrically conductive material, with a first recessed portion that accommodates the first mesh member provided on one face and a second recessed portion that accommodates the second mesh member and a third recessed portion that accommodates an electrolytic membrane provided on another face. The fuel cell also includes the electrolytic membrane. The plate is provided with a pair of oxidizing gas passages that are respectively continuous with opposite ends of the first recessed portion and a pair of fuel passages that are respectively continuous with opposite ends of the second recessed portion. The first mesh member is accommodated in the first recessed portion such that the opposite side from the catalyst layer is in contact with a bottom face of the first recessed portion, and the second mesh member is accommodated in the second recessed portion such that the opposite side from the catalyst layer is in contact with a bottom face of the second recessed portion.

### BRIEF DESCRIPTION OF THE DRAWINGS

FIG. 1 is a sectional view of first and second mesh members that are used in stacks in Examples 1 to 4.

FIG. 2 is a sectional view of a separator and the like in Example 1.

FIG. 3 is an enlarged partial sectional view of a membrane electrode assembly in Example 1.

FIG. 4 is a sectional view of a cell in Example 1.

FIG. 5 is an oblique view of a stack in Example 1.

FIG. 6 is a structural diagram of a fuel cell system in Example 1.

FIG. 7 is a sectional view of a cell in Example 2.

FIG. 8 is a sectional view of a cell in Example 3.

FIG. 9 is a sectional view of a cell in Example 4.

FIG. 10 is a sectional view of first and second mesh members that are used in stacks in Example 5.

FIG. 11 is a sectional view of a separator and the like in Example 5.

FIG. 12 is a sectional view of a cell in Example 5.

FIG. 13 is a graph that shows IV characteristics of Example 5.

FIG. 14 is an exploded oblique view of a conventional cell.

FIG. 15 is an enlarged partial sectional view of a conventional membrane electrode assembly.

### DESCRIPTION OF THE REFERENCE NUMERALS

23 . . . PLATE
21, 51 . . . POROUS BODY (FIRST MESH MEMBER)
22, 52 . . . POROUS BODY (SECOND MESH MEMBER)
25, 54 . . . ELECTROLYTIC MEMBRANE
51c, 52c . . . CATALYST LAYER
21a, 22a . . . DRAIN LAYER
21b, 22b, 51b, 52b . . . MICRO-POROUS LAYER
26 . . . CATHODE
27 . . . ANODE
24 . . . MEMBRANE ELECTRODE ASSEMBLY
20 . . . SEPARATOR
30, 70 . . . CELL
31 . . . STACK

### BEST MODES FOR CARRYING OUT THE INVENTION

Examples 1 to 5 that put the present invention into practice will be explained below with reference to the attached drawings.

### EXAMPLE 1

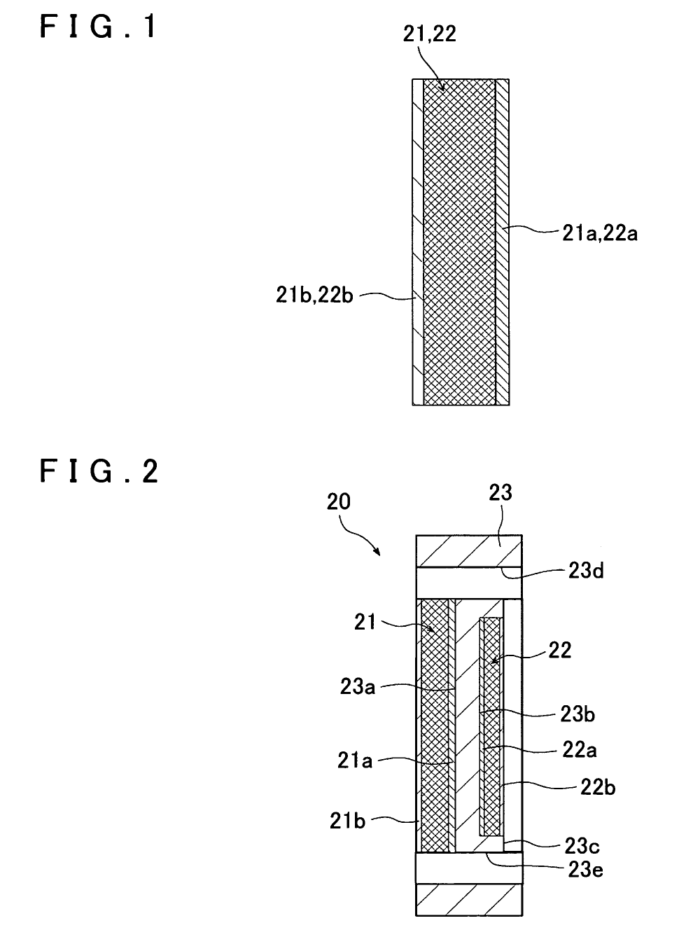

In Example 1, a fuel cell stack uses sheet-like first and second mesh members 21, 22, as shown in FIG. 1. The first and second mesh members 21, 22 are formed into sheet-like meshes of electrically conductive, hydrophilic fibers made of titanium fiber. Each of the first and second mesh members 21, 22 is structured such that the fibers run diagonally in the thickness direction, with the diameters of the fibers being greater on a side toward a plate 23, described later, on which side the fibers form a surface, and with the density of the fibers being higher on a side toward an electrolytic membrane 24, described later, and lower on the side toward the plate 23. The contact angles of water with the first and second mesh members 21, 22 are 40 degrees and 30 degrees, respectively.

Further, drain layers 21a, 22a that are made of an electrically conductive polymer and have hydrophilic and water-absorbing functions are formed such that each covers one entire face of the first and second mesh members 21, 22, respectively. Water-repellent micro-porous layers 21b, 22b that are made of carbon particles, PTFE, and an electrically conductive filler are formed such that each covers another entire face of the first and second mesh members 21, 22, respectively. The contact angle of water with the drain layers 21a, 22a is 30 degrees, and the water absorption rate is 200 percentages. The contact angle of water with the micro-porous layers 21b, 22b is greater than 120 degrees.

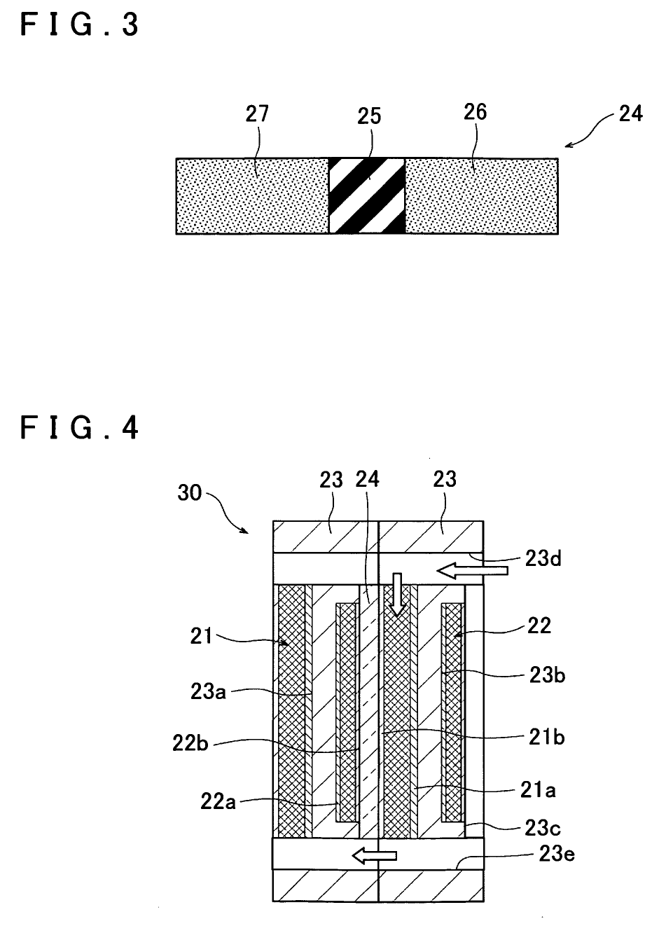

The stack also uses the plate 23 that is made of an electrically conductive material and forms a sheet, as shown in FIG. 2. A first recessed portion 23a that accommodates the first mesh member 21 is provided on one face of the plate 23. A second recessed portion 23b that accommodates the second mesh member 22 and a third recessed portion 23c that accommodates a membrane electrode assembly 24 (refer to FIG. 3) are provided on another face of the plate 23.

A pair of oxidizing gas passages 23d, 23e that are respectively continuous with opposite ends of the first recessed portion 23a is provided in the plate 23. A pair of fuel passages, not shown in the drawings, that are respectively continuous with opposite ends of the second recessed portion 23b is also provided in the plate 23. The positions of the oxidizing gas passages 23d, 23e and the fuel passages are offset by 90 degrees, such that the oxidizing gas and the fuel are supplied at right angles to one another.

The first mesh member 21 is accommodated in the first recessed portion 23a of the plate 23. The drain layer 21a of the first mesh member 21 is in contact with the bottom face of the first recessed portion 23a, and the micro-porous layer 21b is positioned on the outer side. Thus each of the continuous open spaces between the fibers of the first mesh member 21 forms an air chamber between the first mesh member 21 and the plate 23.

Furthermore, the second mesh member 22 is accommodated in the second recessed portion 23b of the plate 23. The drain layer 22a of the second mesh member 22 is in contact with the bottom face of the second recessed portion 23b, and the micro-porous layer 22b is positioned on the outer side. Thus each of the continuous open spaces between the fibers of the second mesh member 22 forms a fuel chamber between the second mesh member 22 and the plate 23. A separator 20 is thus formed.

The membrane electrode assembly 24 that is used in the stack includes an electrolytic membrane 25, a cathode 26 that is joined to one face of the electrolytic membrane 25, and an anode 27 that is joined to another face of the electrolytic membrane 25, as shown in FIG. 3. The cathode 26 and the anode 27 each include a catalyst layer that is positioned on one side of the electrolytic membrane 25, but adjacent to the catalyst layers they do not have conventional diffusion layers that are made of carbon particles, carbon fibers, carbon paper, or the like.

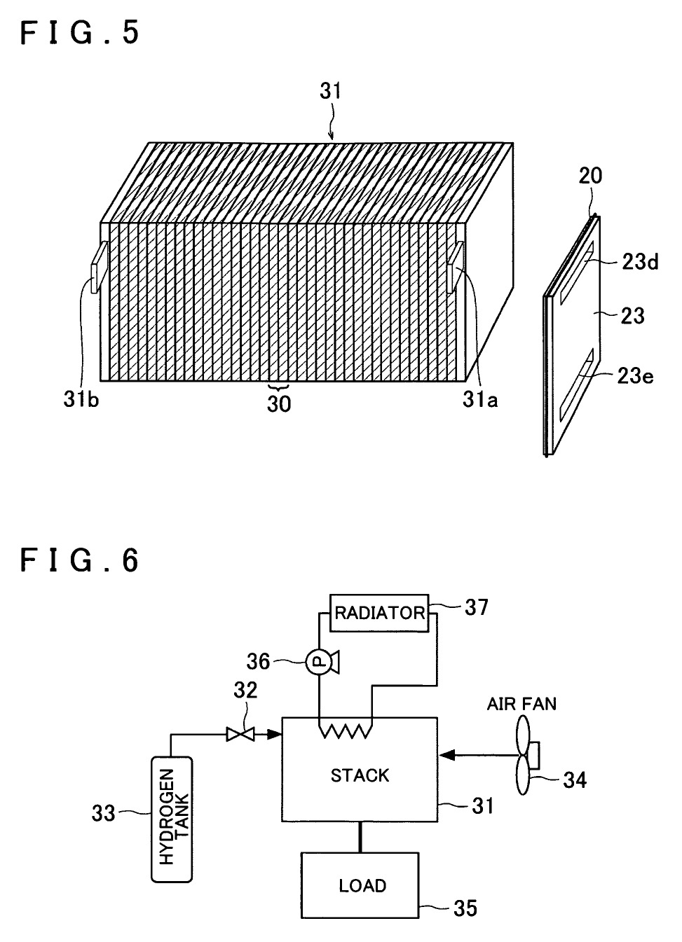

In the separator 20, as shown in FIG. 4, the membrane electrode assembly 24 is accommodated in the third recessed portion of the plate 23, and a cell 30 is formed by the separator 20, the membrane electrode assembly 24, and another separator 20. Adjacent cells 30 share the separator 20. Then, as shown in FIG. 5, a plurality of the cells 30 are stacked and electrically connected in series to form a stack 31. In the stack 31, all of the oxidizing gas passages 23d, 23e are continuous through all of the cells 30, and all of the fuel passages are continuous through all of the cells 30. The fuel passages are continuous between a fuel supply inlet 31a and a fuel discharge outlet 31b. Power collection of the stack 31 is performed by the fuel supply inlet 31a and the fuel discharge outlet 31b.

A hydrogen tank 33 is connected to the fuel supply inlet 31a of the stack 31 through a valve 32, as shown in FIG. 6. In addition, air is supplied as an oxidizing gas to the oxidizing gas passages 23d, 23e of the stack 31 by an air fan 34. The fuel supply inlet 31a and the fuel discharge outlet 31b at opposite ends of the stack 31 electrically connected to a load 35, such as an automobile motor or the like. The bottom of the stack 31 is connected to a radiator 37 by a pump 36 such that circulation occurs. A fuel cell system is thus formed.

In the stack 31 that is configured as described above, an electromotive force is generated by an electrochemical reaction between the air that is supplied to the oxidizing gas passages 23d, 23e and the hydrogen that is supplied to the fuel passages.

During this process, the oxidizing gas and the fuel can be delivered respectively to the air chambers and the fuel chambers between the fibers of the first and second mesh members 21, 22 respectively. At the same time, surface tension that is due to the fibers causes water that is formed and residual water to diffuse in the thickness direction along the surfaces of the fibers, such that the water that is formed and the residual water are less likely to block the open spaces that are formed between the fibers. Therefore, in the stack 31, air and hydrogen pressure losses do not readily occur, and excellent supply performance can be achieved for the oxidizing gas and the fuel.

Furthermore, because the surface tension that is due to the fibers causes the water that is formed and the residual water to diffuse in the thickness direction along the surfaces of the fibers in the air chambers and the fuel chambers, the interiors of the electrodes do not dry out readily. Moreover, the fibers that a porous body has are in contact with the catalyst layer, so a stable contact surface area can be ensured. Excellent power collection performance can therefore be achieved in the stack 31.

In particular, in the stack 31, because each of the drain layers 21a, 22a is respectively formed as a single piece on the entire surface of the first mesh member 21 and the second mesh member 22 on the side toward the plate 23, water droplets that diffuse in the thickness direction of the first and second mesh members 21, 22 are collected in the drain layers 21a, 22a, and the collected water forms layers of water over the drain layers 21a, 22a. The water layers flow of their own weight or under air pressure and are preferably drained to the outside of the fuel cell.

Therefore, the fiber surfaces of the first and second mesh members 21, 22 and the drain layers 21a, 22a form the layers of water and serve as flow passages where the flow of the water occurs. In addition, the open spaces between the fibers form excellent layers for the passage of gases, without being immersed in the water, such that they serve as flow passages through which gases flow. It is therefore possible to make a clear distinction between these two types of flow passages. The layers of the gases and the water are clearly distinguished within the electrodes, so the flow of the gases and the flow of the water are conceptually defined as a two-layer flow. Both the oxidizing gas and the fuel are included in the category of the gases.

Because each of the water-repellent multi-porous layers 21b, 22b is respectively formed on the first mesh member 21 and the second mesh member 22 on the side toward the membrane electrode assembly 24, any excess portion of the water that is formed is easily discharged to the outside from the catalyst layers. The discharged water that is formed can be transferred to the fibers, where it readily diffuses from the side toward the membrane electrode assembly 24 to the side toward the plate 23.

Therefore, the stack 31 in Example 1 can improve both the power collection performance and the supply performance for the air and the hydrogen. This makes it possible for the stack 31 to achieve high power density and highly efficient electric power generation.

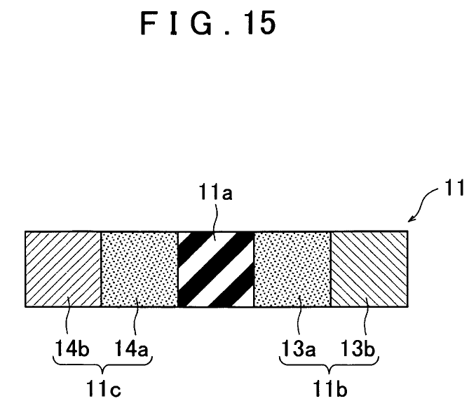

Furthermore, in the stack 31, the cathode 26 and the anode 27 of the membrane electrode assembly 24 are respectively configured from only the catalyst layer, thus simplifying the structure of the membrane electrode assembly 24. Because the conventional diffusion layer is not required, lower manufacturing costs can be achieved. Note that a membrane electrode assembly 11 shown in FIG. 15 can also be used in the stack 31.

Moreover, the first and second mesh members 21, 22 deliver the oxidizing gas and the like, so it is not necessary to use a separator that has raised ribs to form the oxidizing gas flow passages and the like. The use of the sheet-like plate 23 makes it possible to make the cell 30 thinner. The effects of the stack 31 in Example 1 thus include more efficient electric power generation, higher output density, a more compact fuel cell, and lower cost.

### EXAMPLE 2

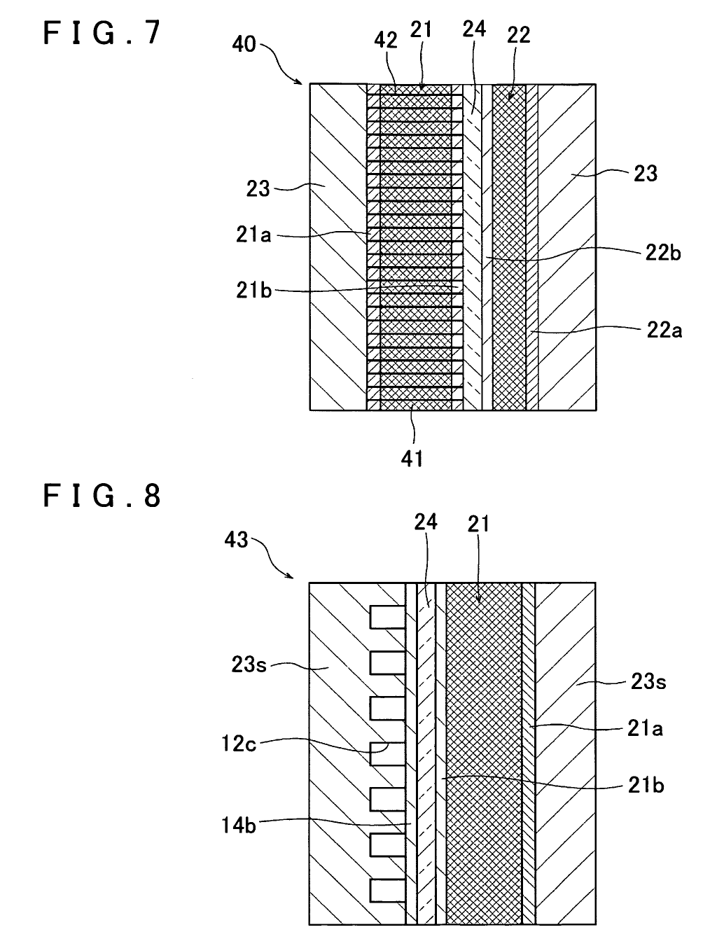

A stack in Example 2 uses a cell 40 that is shown in FIG. 7. In the cell 40, a first mesh member 21 is formed from electrically conductive fibers 41 and hydrophilic fibers 42. Other features of the configuration are the same as in Example 1.

That is, the cell 40 includes the first mesh member 41, a second mesh member 22, a plate 23, and a membrane electrode assembly 24.

The first mesh member 41 is formed into a sheet-like mesh of the electrically conductive fibers and the hydrophilic fibers, with a hydrophilic drain layer 21a formed on one face and a water-repellent multi-porous layer 21b formed on another face.

The second mesh member 22 is formed into a sheet-like mesh of electrically conductive, hydrophilic fibers, with a hydrophilic drain layer 22a formed on one face and a water-repellent multi-porous layer 22b formed on another face.

The plate 23 is made of an electrically conductive material and forms a sheet, with a first recessed portion that accommodates the first mesh member 41 provided on one face, and a second recessed portion that accommodates the second mesh member 22 and a third recessed portion that accommodates the membrane electrode assembly 24 provided on another face.

A pair of oxidizing gas passages, not shown in the drawings, that are respectively continuous with opposite ends of the first recessed portion is provided in the plate 23, as is a pair of fuel passages, not shown in the drawings, that are respectively continuous with opposite ends of the second recessed portion. The first mesh member 41 is accommodated in the first recessed portion such that the drain layer 21a is in contact with the bottom face of the first recessed portion. The second mesh member 22 is accommodated in the second recessed portion such that the drain layer 22a is in contact with the bottom face of the second recessed portion.

The membrane electrode assembly 24 includes an electrolytic membrane 25, a cathode 26 that is joined to one face of the electrolytic membrane 25 and includes a catalyst layer, and an anode 27 that is joined to another face of the electrolytic membrane 25 and includes a catalyst layer.

This stack can achieve the same sort of operative effects as Example 1. Furthermore, because the hydrophilic fibers are in the multi-porous layer 22b and water within the multi-porous layer 22b is in contact with the hydrophilic fibers, the stack has a greater capacity to transport the water that is formed. Additional hydrophilicization treatment of metal fibers is also not required.

### EXAMPLE 3

A stack in Example 3 uses a cell 43 that is shown in FIG. 8. In the cell 43, a first mesh member 21 is positioned on a cathode 26 side of a membrane electrode assembly 24, and a conventional, groove-shaped, fuel flow passage 12c is formed by a separator 23s on an anode 27 side of the membrane electrode assembly 24. Further, a conventional diffusion layer 14b (refer to FIG. 15) that is made of carbon fibers is formed in the anode 27. Other features of the configuration are the same as in Example 1.

That is, the cell 43 includes the first mesh member 21, the separator 23s, and the membrane electrode assembly 24.

The first mesh member 21 is formed into a sheet-like mesh of electrically conductive, hydrophilic fibers, with a hydrophilic drain layer 21a formed on one face and a water-repellent multi-porous layer 21b formed on another face.

The separator 23s is formed into a sheet shape that is made of an electrically conductive material, and it is provided on one face with a first recessed portion that accommodates the first mesh member 21. On another face of the separator 23s, a third recessed portion is provided that accommodates the membrane electrode assembly 24, and a plurality of the groove-shaped fuel flow passages 12c is formed by providing ribs on the bottom face of the third recessed portion.

A pair of oxidizing gas passages, not shown in the drawings, that are respectively continuous with opposite ends of the first recessed portion is provided in the separator 23s, as is a pair of fuel passages, not shown in the drawings, that are continuous with the fuel flow passages 12c. The first mesh member 21 is accommodated in the first recessed portion such that the drain layer 21a is in contact with the bottom face of the first recessed portion.

The membrane electrode assembly 24 includes an electrolytic membrane 25, the cathode 26 that is joined to one face of the electrolytic membrane 25 and includes a catalyst layer, and the anode 27 that is joined to another face of the electrolytic membrane 25 and includes a catalyst layer 14a and the diffusion layer 14b.

In this stack, a two-layer flow can flow only on the cathode 26 side.

### EXAMPLE 4

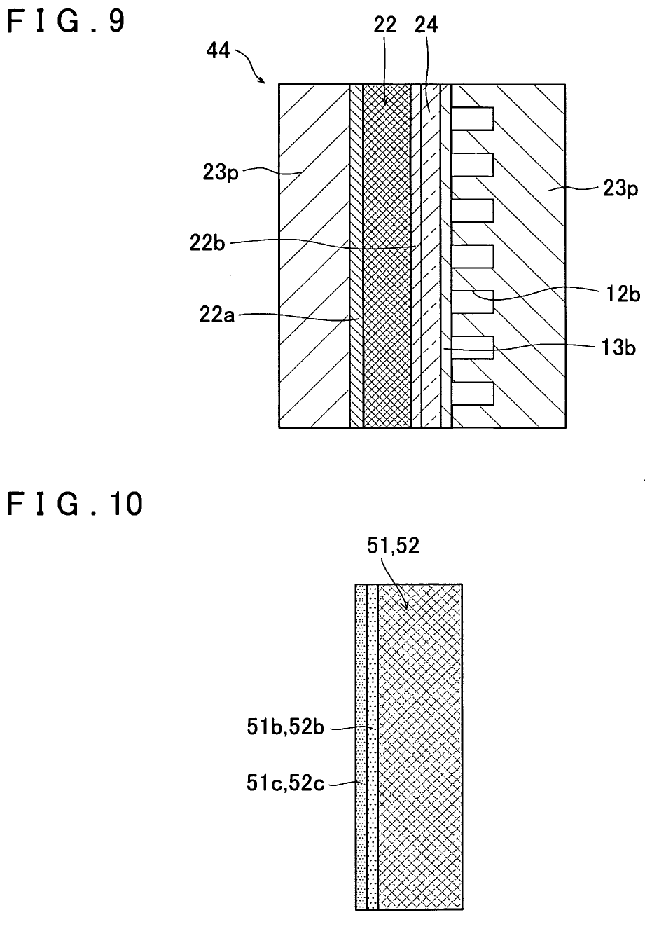

A stack in Example 4 uses a cell 44 that is shown in FIG. 9. In the cell 44, a second mesh member 22 is positioned on an anode 27 side of a membrane electrode assembly 24, and a conventional, groove-shaped, oxidizing gas flow passage 12b is formed by a plate 23 on a cathode 26 side of the membrane electrode assembly 24. Further, a conventional diffusion layer 13b (refer to FIG. 15) that is made of carbon fibers is formed in the cathode 26. Other features of the configuration are the same as in Example 1.

That is, the cell 44 includes the second mesh member 22, a separator 23p, and the membrane electrode assembly 24.

The second mesh member 22 is formed into a sheet-like mesh of electrically conductive, hydrophilic fibers, with a hydrophilic drain layer 22a formed on one face and a water-repellent multi-porous layer 22b formed on another face.

The separator 23p is formed into a sheet shape that is made of an electrically conductive material. A second recessed portion that accommodates the membrane electrode assembly 24 is provided on one face of the separator 23p, and a plurality of the groove-shaped oxidizing gas flow passages 12b is formed by providing ribs on the bottom face of the second recessed portion. On another face of a separator 23s, a first recessed portion is provided that accommodates the second mesh member 22.

A pair of oxidizing gas passages, not shown in the drawings, that are continuous with the oxidizing gas flow passages 12b is provided in the separator 23p, as is a pair of fuel passages, not shown in the drawings, that are respectively continuous with opposite ends of the second recessed portion. The second mesh member 22 is accommodated in the second recessed portion such that the drain layer 22a is in contact with the bottom face of the second recessed portion.

The membrane electrode assembly 24 includes an electrolytic membrane 25, the cathode 26 that is joined to one face of the electrolytic membrane 25 and includes a catalyst layer 13a and the diffusion layer 13b, and the anode 27 that is joined to another face of the electrolytic membrane 25 and includes a catalyst layer.

In this stack, a two-layer flow can flow only on the anode 27 side.

### EXAMPLE 5

A fuel cell stack in Example 5 uses first and second mesh members 51, 52 that are shown in FIG. 10. Water-repellent multi-porous layers 51b, 52b are respectively formed on one face of the first and second mesh members 51, 52, and catalyst layers 51c, 52c are also respectively formed on the same face of the first and second mesh members 51, 52. Each of the catalyst layers 51c, 52c includes a catalyst carrier carbon, in which a catalyst is carried by carbon particles, and an electrolytic solution.

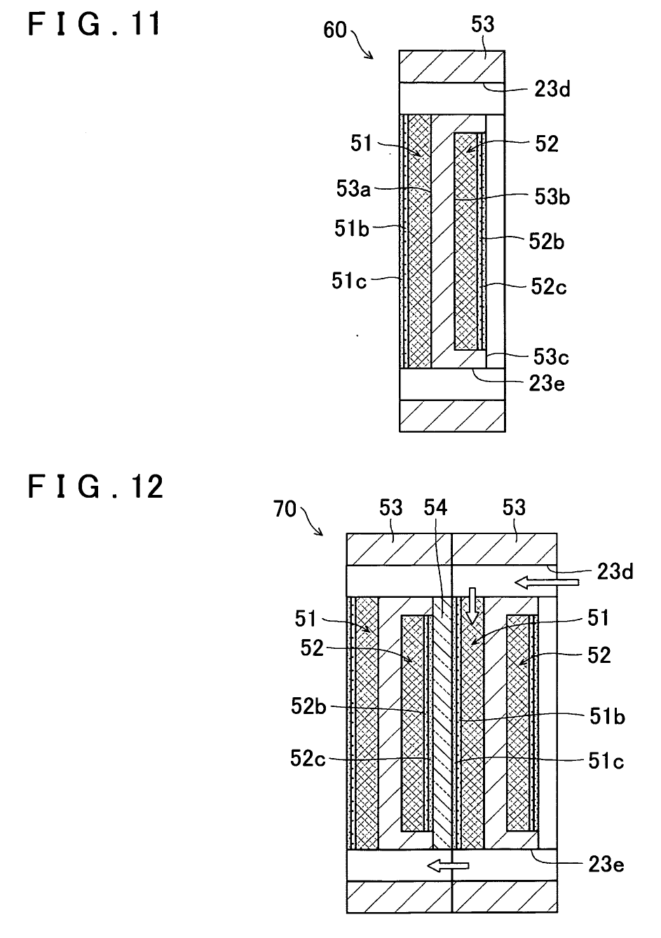

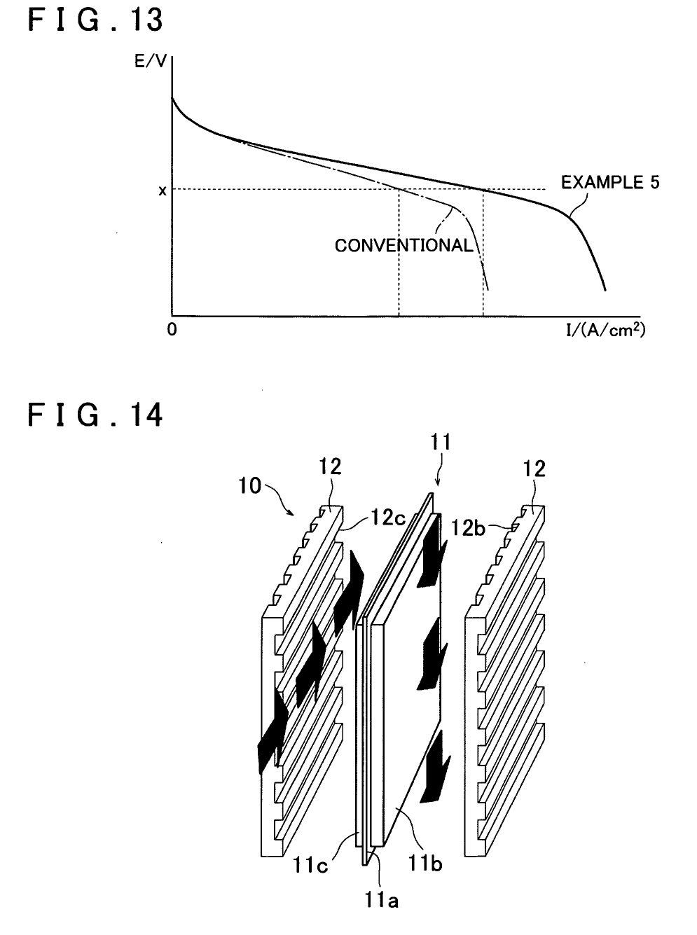

The stack also uses a plate 53 that is made of an electrically conductive material and forms a sheet, as shown in FIG. 11. A first recessed portion 53a that accommodates the first mesh member 51 is provided on one face of the plate 53. A second recessed portion 53b that accommodates the second mesh member 52 and a third recessed portion 53c that accommodates an electrolytic membrane 54 (refer to FIG. 12) are provided on another face of the plate 53.

The first mesh member 51 is accommodated in the first recessed portion 53a of the plate 53. The opposite side of the first mesh member 51 from the catalyst layer 51c is in contact with the bottom face of the first recessed portion 53a, and the catalyst layer 51c and the micro-porous layer 51b are positioned on the outer side. Thus each continuous open space between fibers of the first mesh member 51 forms an air chamber between the first mesh member 51 and the plate 53.

Furthermore, the second mesh member 52 is accommodated in the second recessed portion 53b of the plate 53. The opposite side of the second mesh member 52 from the catalyst layer 52c is in contact with the bottom face of the second recessed portion 53b, and the catalyst layer 52c and the micro-porous layer 52b are positioned on the outer side. Thus each continuous open space between fibers of the second mesh member 52 forms a fuel chamber between the second mesh member 52 and the plate 53. A separator 60 is thus formed.

In the separator 60, as shown in FIG. 12, the electrolytic membrane 54 is accommodated in the third recessed portion 53c of the plate 53, and a cell 70 is formed by the separator 60, the electrolytic membrane 54, and another separator 60. The electrolytic membrane 54 is made of a solid polymer membrane such as Nafion or the like. Other features of the configuration are the same as in Example 1.

That is, the cell 70 includes the first and second mesh members 51, 52, the plate 53, and the electrolytic membrane 54.

The first mesh member 51 is formed into a sheet-like mesh of one of electrically conductive, hydrophilic fibers and a combination of electrically conductive fibers and hydrophilic fibers, with the water-repellent multi-porous layer 51b formed on one face and the catalyst layer 51c also formed on the same face.

The second mesh member 52 is formed into a sheet-like mesh of one of electrically conductive, hydrophilic fibers and a combination of electrically conductive fibers and hydrophilic fibers, with the water-repellent multi-porous layer 52b formed on one face and the catalyst layer 52c also formed on the same face.

The plate 53 is made of an electrically conductive material, with the first recessed portion 53a that accommodates the first mesh member 51 provided on one face and the second recessed portion 53b that accommodates the second mesh member 52 and the third recessed portion 53c that accommodates the electrolytic membrane 54 provided on another face.

A pair of oxidizing gas passages 23d that are respectively continuous with opposite ends of the first recessed portion 53a is provided in the plate 53, as is a pair of fuel passages, not shown in the drawings, that are respectively continuous with opposite ends of the second recessed portion 53b. The first mesh member 51 is accommodated in the first recessed portion 53a such that the opposite side from the catalyst layer 51c is in contact with the bottom face of the first recessed portion 53a, and the second mesh member 52 is accommodated in the second recessed portion 53b such that the opposite side from the catalyst layer 52c is in contact with the bottom face of the second recessed portion 53b.

In the stack that is configured as described above, because the water-repellent micro-porous layers 51b, 52b are respectively provided between the first and second mesh members 51, 52 and the catalyst layers 51c, 52c, electrons move easily from the catalyst layers 51c, 52c to the first and second mesh members 51, 52, and water within the catalyst layers 51c, 52c moves to the multi-porous layers 51b, 52b, such that the electrochemical reaction in the catalyst layers 51c, 52c is less likely to be inhibited. Other operative effects are the same as in Example 1.

A comparison was made of IV characteristics of the stack described above in Example 5 and a conventional stack that uses a cell like that shown in FIGS. 14 and 15. The results are shown in FIG. 13. FIG. 13 indicates that the IV characteristics are equal in the low current range, but that as the current moves into the high current range, the voltage in the stack in Example 5 is maintained longer without dropping off. This indicates that the water drainage performance is better than in the conventional stack and that the gases are well distributed. In the conventional stack, the voltage drops off because air and water mix in flow passages in the electrodes, plugging the flow passages, but with the formation of a two-layer flow, no voltage drop-off is seen. Accordingly, it can be concluded that the stack in Example 5 shows IV characteristics that are superior to those of the conventional stack.

The present invention has been explained above in the contexts of Examples 1 to 5, but the present invention is not limited by the Examples 1 to 5 described above, and various modifications can be made insofar as they are within the scope of the present invention.

### INDUSTRIAL APPLICABILITY

The present invention can be used in a fuel cell system such as a mobile power source for an electric automobile and the like, a stationary outdoor power source, a portable power source, and the like.

1. A fuel cell electrode comprising:
a porous body that is shaped like a sheet, that is provided on one face with a plate made of an electrically conductive material, that has a plurality of mutually continuous open spaces and is electrically conductive, with each of the open spaces forming one of an air chamber and a fuel chamber between the porous body and the plate; and
a catalyst layer that is formed as a single unit with the porous body on another face of the porous body and that is in contact with an electrolytic membrane.

2. The fuel cell electrode according to claim 1, wherein:
the porous body is a mesh member that is formed into a three-dimensional mesh shape.

3. The fuel cell electrode according to claim 2, wherein;
fibers that form the mesh member have a first density on a side of the porous body that is facing the electrolytic membrane and a second density which is lower than the first density on the side that is facing the plate.

4. The fuel cell electrode according to claim 1, wherein:
a hydrophilic drain layer is formed over an entire surface of the porous body that is in contact with the plate.

5. The fuel cell electrode according to claim 1, further comprising:
a micro-porous layer between the porous body and the catalyst layer that has a plurality of mutually continuous micro-pores and is electrically conductive.

6. The fuel cell electrode according to claim 5, wherein:
the micro-porous layer is water-repellent.

7. The fuel cell electrode according to claim 4, wherein:
the micro-porous layer includes an electrically conductive filler.

8. A fuel cell, comprising:
a fuel cell electrode according to claim 1 serving as a cathode;
a fuel cell electrode according to claim 1 serving as an anode; and
wherein the electrolytic membrane is between one face of the cathode and one face of the anode and is in contact with the catalyst layer.

9. The fuel cell according to claim 8, wherein:
a hydrophilic drain layer is formed over an entire surface of the plate that is in contact with the porous body.

10. A fuel cell stack, wherein:
a plurality of the cells according to claim 8 are electrically connected in series.

11. The fuel cell electrode according to claim 2 wherein a hydrophilic drain layer is formed over an entire surface of the porous body that is in contact with the plate.

12. The fuel cell electrode according to claim 3 wherein a hydrophilic drain layer is formed over an entire surface of the porous body that is in contact with the plate.

13. The fuel cell electrode according to claim 2, further comprising:
a micro-porous layer located between the porous body and the catalyst layer and having a plurality of mutually continuous micro-pores, the micro-porous layer being electrically conductive.

14. The fuel cell electrode according to claim 3, further comprising:
a micro-porous layer located between the porous body and the catalyst layer and having a plurality of mutually continuous micro-pores, the micro-porous layer being electrically conductive.

15. The fuel cell electrode according to claim 4, further comprising:
a micro-porous layer located between the porous body and the catalyst layer and having a plurality of mutually continuous micro-pores, the micro-porous layer being electrically conductive.
